(19) United States
(12) Patent Application Publication
(10) Pub. No.: US 2016/0078530 A1
(43) Pub. Date: Mar. 17, 2016

(54) Validating Card Numbers

(71) Applicant: TENCENT TECHNOLOGY (SHENZHEN) COMPANY LIMITED, Shenzhen City (CN)

(72) Inventors: Wenpeng ZHANG, Shenzhen City (CN); Wenjing ZHANG, Shenzhen City (CN)

(21) Appl. No.: 14/951,586

(22) Filed: Nov. 25, 2015

Related U.S. Application Data
(63) Continuation of application No. PCT/CN2014/077018, filed on May 8, 2014.

(30) Foreign Application Priority Data
May 30, 2013 (CN) 201310208459.6

(51) Int. Cl. G06Q 40/02

(52) U.S. Cl. CPC G06Q 40/02

(57) ABSTRACT

A method of validating card numbers is described. A card number input by a user using a terminal device is obtained. It is judged whether an organization identity obtained from the card number is an identity of an organization that issues cards. A determination is made that the card number is invalid if the organization identity obtained from the card number is not an identity of an organization that issues cards.

### CROSS-REFERENCE TO RELATED APPLICATIONS

This application is a continuation of International Application No. PCT/CN2014/077018, filed May 8, 2014. This application claims the benefit and priority of Chinese Application No. 201310208459.6, filed May 30, 2013. The entire disclosures of each of the above applications are incorporated herein by reference.

### FIELD

The present disclosure relates to validating techniques, and validating card numbers.

### BACKGROUND

This section provides background information related to the present disclosure which is not necessarily prior art.

People are sometimes required to input a bank card number to associate one's bank account with a charging service. Bank card numbers input are then validated to determine their authenticity.

The current means of validation is simple. For example, validation may only involve validating whether each character input from the card number is a number. Thus, a card number having passed the validation process may not actually be a valid bank card number.

### SUMMARY

This section provides a general summary of the disclosure, and is not a comprehensive disclosure of its full scope or all of its features.

Various embodiments of the present disclosure provide a method and an apparatus for validating card numbers so as to improve the accuracy of validation results.

Various embodiments provide a method for validating card numbers which may include:

obtaining a card number input by a user using a terminal device; and

determining whether an organization identity obtained from the card number is an identity of an organization that issues cards and making a determination that the card number is invalid if the organization identity obtained from the card number is not the identity of the organization that issues cards.

Various embodiments also provide an apparatus for validating card numbers which may include a processor and a memory, wherein the memory comprises a series of computer-executable instructions which may cause the processor to perform the following:

obtaining a card number input by a user using a terminal device,

determining whether an organization identity obtained from a card number is an identity of an organization that issues cards, and

making a determination that the card number is invalid if the identity of the organization obtained from the card number is not the identity of the organization that issues cards.

According to the above technical mechanisms, the validity of card numbers is determined based on a composition rule of card numbers and identities of organizations that issue cards. A card number can pass the validation when the card number conforms to the composition rule and an organization identity obtained from the card number is an identity of a valid organization that issues cards. Comprehensive factors are checked according to various embodiments of the present disclosure compared to conventional validating mechanisms. Thus, the validation results are more accurate.

Further areas of applicability will become apparent from the description provided herein. The description and examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Features of the present disclosure are illustrated by way of embodiment and not limited in the following figures, in which like numerals indicate like elements.

FIG. 1 is a diagram illustrating a communication system according to various embodiments;

FIG. 2 is a diagram illustrating a computer according to various embodiments;

FIG. 3 is a flowchart illustrating a method of validating a card number according to various embodiments;

FIG. 4 is a flowchart illustrating a static validating method according to various embodiments;

FIG. 5 is a diagram illustrating storage data in a sub library according to various embodiments;

FIG. 6 is a flowchart illustrating a method of determining card origin information of a bank card number according to various embodiments; and

FIG. 7 is a diagram illustrating modules of an apparatus for validating card numbers according to various embodiments.

Corresponding reference numerals indicate corresponding parts throughout the several views of the drawings.

### DETAILED DESCRIPTION

Example embodiments will now be described more fully with reference to the accompanying drawings.

For simplicity and illustrative purposes, the present disclosure is described by referring mainly to an embodiment thereof. In the following description, numerous details are set forth in order to provide a thorough understanding of the present disclosure. It will be readily apparent however, that the present disclosure may be practiced without limitation to these details. In other instances, some methods and structures have not been described in detail so as not to unnecessarily obscure the present disclosure. As used herein, the term “includes” means includes but not limited to, the term “including” means including but not limited to. The term “based on” means based at least in part on. Quantities of an element, unless specifically mentioned, may be one or a plurality of, or at least one.

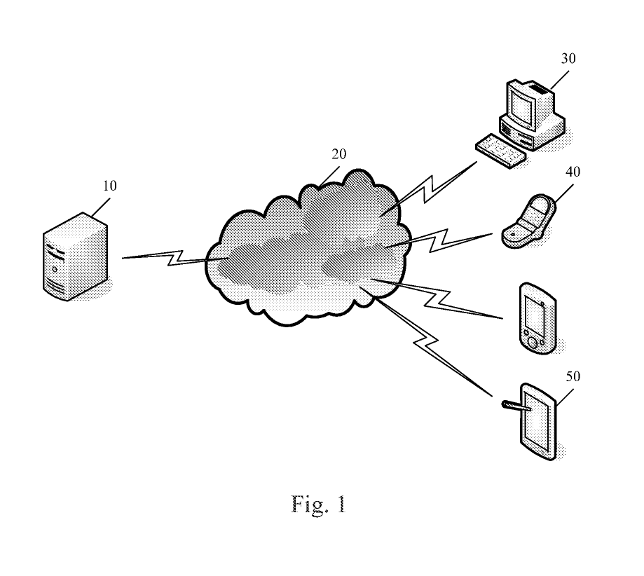

FIG. 1 is a diagram illustrating a communication system according to various embodiments of the present disclosure. As shown in FIG. 1, the communication system includes at least a server 10, a network 20, and terminal devices. The user terminal devices may be a personal computer 30, a mobile phone 40, a tablet computer 50, or other mobile Internet devices (MID), e.g., e-book reading devices, portable game consoles, and the like that are capable of accessing the Internet via various wireless communications techniques. The method of validating card numbers is applicable to both the above server and the user terminals. In the following, an apparatus that implements the method of validating card numbers is referred to as a computing device or a computer. When the computing device that implements the method of validating card numbers is the server, user terminals serve as the information transport medium between users and the server, i.e., data exchanged between users and the server are transported by the user terminals and the network 20.

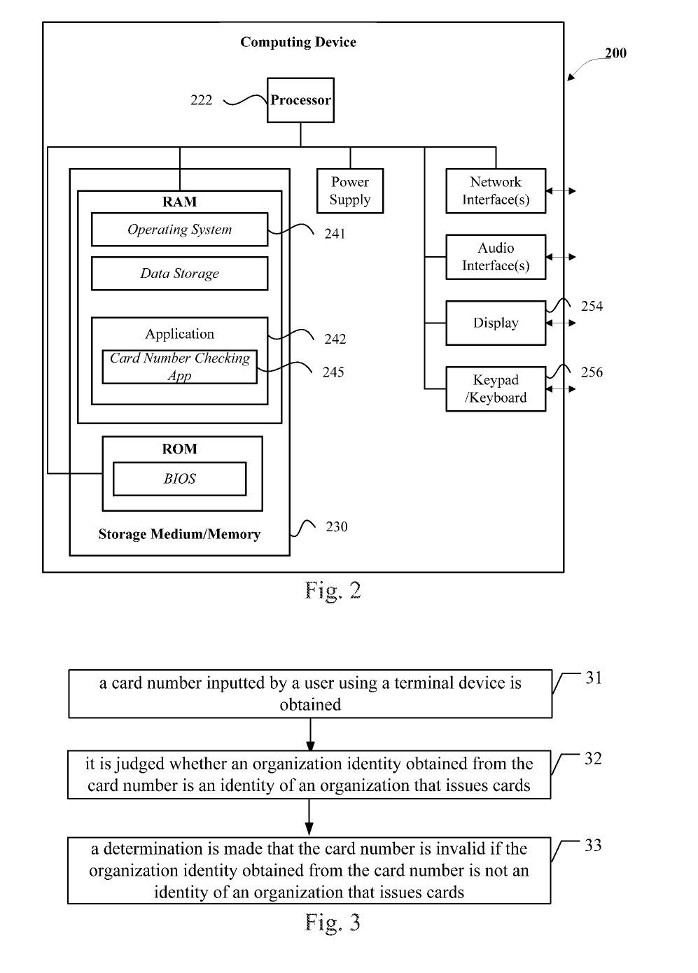

According to various embodiments, a computing device may execute methods and software systems of the present disclosure. FIG. 2 is a diagram illustrating an embodiment of a computing device. As shown in FIG. 2, computing device 200 may be a computing device capable of executing a method and apparatus of the present disclosure. The computing device 200 may, for example, be a device such as a personal desktop computer or a portable device, such as a laptop computer, a tablet computer, a cellular telephone, or a smart phone. The computing 200 may also be a server that connects to the above devices locally or via a network.

The computing device 200 may vary in terms of capabilities or features. Claimed subject matter is intended to cover a wide range of potential variations. For example, the computing device 200 may include a keypad/keyboard 256. It may also comprise a display 254, such as a liquid crystal display (LCD), or a display with a high degree of functionality, such as a touch-sensitive color 2D or 3D display. In contrast, however, as another example, a web-enabled computing device 200 may include one or more physical or virtual keyboards and mass storage medium 230.

The computing device 200 may also include or may execute a variety of operating systems 241, including an operating system, such as a Windows™ or Linux™, or a mobile operating system, such as iOS™, Android™, or Windows Mobile™. The computing device 200 may include or may execute a variety of possible applications 242, such as a card number validating application 245. An application 242 may communicate with other devices via a network.

The computing device 200 may include one or more storage medium/memory 230 and one or more processors 222 in communication with the non-transitory processor-readable storage media 230. For example, the non-transitory processor-readable storage media 230 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 230 may store a series of instructions or units and/or modules that comprise the series of instructions for conducting operations described in the present disclosure. The one or more processors may be configured to execute the series of instructions and perform the operations according to various embodiments of the present disclosure.

Various embodiments of the present disclosure provide a mechanism of validating card numbers. FIG. 3 is a flowchart illustrating a method of validating a card number according to various embodiments of the present disclosure. As shown in FIG. 3, the method may include the following procedures.

Block 31: A card number input by a user using a terminal device is obtained. According to various embodiments, the method is implemented by the terminal device of the user, e.g., the user terminal device as shown in FIG. 1. According to various embodiments, the method is implemented by another device connected to the terminal device via a network, e.g., a server device as shown in FIG. 1. The card number input by the user is transmitted to the server device via the network after the user has finished inputting the card number or each character of the card number is transmitted to the server device immediately after the character is input by the user. The terminal device or the server device may be the computer as shown in FIG. 2.

Block 32: It is determined whether an organization identity obtained from the card number is an identity of an organization that issues cards. The organization identity refers to an organization identity included in the card number representing the identity of the organization that issues the card. According to various embodiments, the card number may be a bank card number or a card number of any card whose card number conforms to a composition rule and includes an identity representing an organization that issues the card. For bank card numbers, the organization identity is a bank identification number (BIN), which is generally identified by the first 6 digits of a bank card number. With regard to other cards, e.g., a gift card for shopping at specified retailers, a discount card, or the like, an organization identity may be included in the card number in a manner defined by the organization that issues the card. The method of obtaining the organization identity from the card number is obtainable from the organization, and is not limited in the present disclosure.

According to various embodiments, the procedure in block 32 may be performed after determining that a user has finished inputting the card number or as soon as it is determined that the organization identity is obtainable from at least one already input character of the card number.

Block 33: A determination is made that the card number is invalid if the organization identity obtained from the card number is not an identity of an organization that issues cards. According to various embodiments, the procedure in block 32 may include determining whether the organization identity obtained from the card number is in a pre-defined library that stores identities of valid organizations that issue cards. The procedure in block 33 may include making a determination that the card number is invalid if the organization identity obtained from the card number is not in the pre-defined library.

According to various embodiments, the pre-defined library may also store card origin information corresponding to each of the identities of valid organizations. The card origin information may include information of an organization and a card type. It may be determined whether the library of organization identities stores card origin information corresponding to the organization identity obtained from the card number and the card origin information is determined to be card origin information of the card number in response to a determination that the library stores the card origin information corresponding to the organization identity. If the library does not store the card origin information, it may be determined whether card origin information set by a user has been obtained and the card origin information set by the user is determined to be the card origin information of the card number. If the card origin information set by the user has not been obtained, information may be presented to prompt the user to provide card origin information and card origin information provided by the user is determined to be the card origin information of the card number.

According to various embodiments, the card origin information of the card number may be presented to the user after the card origin information of the card number is determined. According to various embodiments, it may be determined whether the card type in the card origin information of the card number is a non-debit card after the card origin information of the card number is determined. The card number is validated using a Luhn algorithm and, if applicable, the card number is determined to be invalid in response to a determination that the card number fails the validation of the Luhn algorithm.

According to various embodiments, it may be determined whether the total number of characters in the card number equals a pre-defined value corresponding to the card origin information of the card number after the card origin information of the card number is determined and the card number is determined to be invalid in response to a determination that the total number of characters in the card number does not equal the pre-defined value. The pre-defined value is a pre-defined total number of characters in a card number corresponding to the card origin information of the card number.

According to various embodiments, it may be determined whether the card number conforms to a composition rule and a determination is made that the card number is invalid if the card number does not conform to the composition rule.

According to various embodiments, the procedure of determining whether the card number conforms to the composition rule may include at least one of the following:
determining whether the first character of the card number is one of pre-defined values;
determining whether a set of at least one character in the card number conforms to a pre-defined rule;
determining whether the total number of characters in the card number is within a pre-defined value range; and
validating the card number using a pre-defined algorithm.

Thus, the card number is determined to be invalid if one of the following determinations is made:
the first character of the card number is not one of the pre-defined values;
the set of at least one character in the card number does not conform to the pre-defined rule;
the total number of characters in the card number is within a pre-defined value range; and/or
the card number fails the validation using the pre-defined algorithm.

According to various embodiments, the prompt information of an error and reasons for the error may be presented to the user in response to a determination that the card number is invalid. If no determination that the card number is invalid is made, the card number may be determined to be valid.

According to various embodiments, a card number that needs to be validated is obtained and validated. It is determined that the card number is valid in response to a determination that the card number conforms to a composition rule of card numbers and that an organization identity obtained from the card number is an identity of a valid organization that issues cards. It is determined that the card number is invalid in response to a determination that the card number does not conform to the composition rule of card numbers or in response to a determination that the organization identity obtained from the card number is not an identity of a valid organization that issues cards.

The following describes the mechanism of the present disclosure by taking bank card numbers as an example.

Various embodiments may adopt a dynamic validating method or a static validating method, which are described in the following, according to the requirements.

According to the static validating method, when the to-be-validated card is a bank card, after a user has finished inputting a bank card number, it is determined whether the bank card number conforms to a composition rule of bank card numbers and whether a bank identity (e.g., the BIN) in the bank card number is a valid bank identity. It is determined that the bank card number is valid if the bank card number conforms to the composition rule of bank card numbers and the bank identity in the bank card number is a valid bank identity.

The method of determining whether the bank card number conforms to a composition rule of bank card numbers may include determining whether each character in the bank card number is a number and determining whether the first character of the bank card number is one of pre-defined values. According to various embodiments, the method may also include determining whether the total number of characters of the bank card number are within a pre-defined value range.

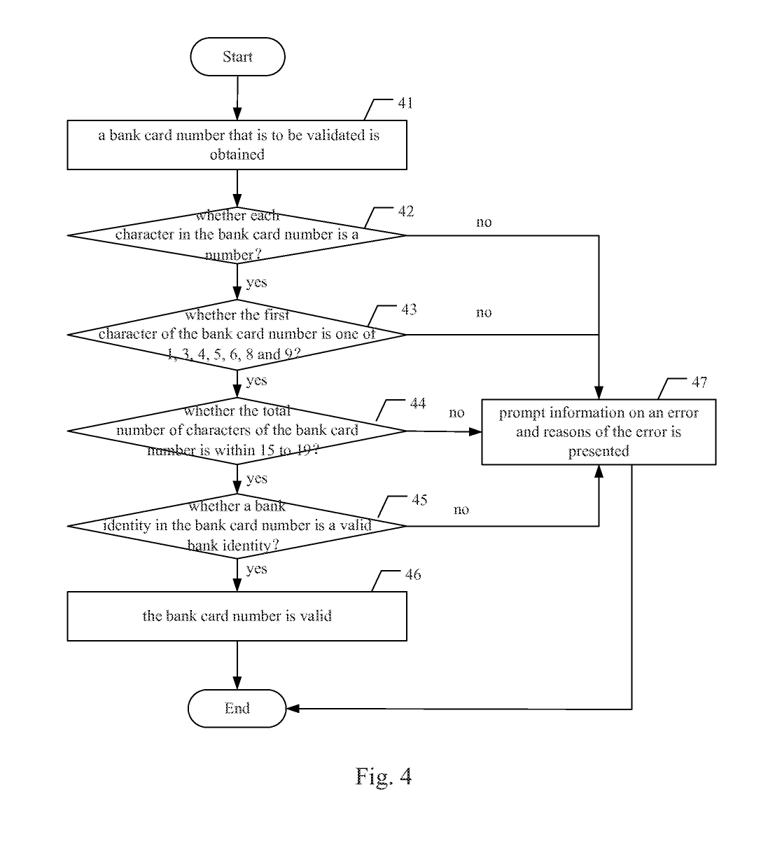

FIG. 4 is a flowchart illustrating a static validating method according to various embodiments of the present disclosure. As shown in FIG. 1, the method may include the following procedures.

Block 41: A bank card number that needs to be validated is obtained. The procedure in block 42 is performed in response to a determination that a user has finished inputting the to-be-validated bank card number.

Block 42: It is determined whether each character in the bank card number is a number. The procedure in block 43 is performed in response to a determination that each character in the bank card number is a number or that the procedure in block 47 is performed in response to a determination that each character in the bank card number is not a number. In various embodiments, bank card numbers include only numerical numbers. In other embodiments, a card number may also include letters, symbols, numbers, or the like.

Block 43: It is judged whether the first character of the bank card number is one of pre-defined values, e.g., 1, 3, 4, 5, 6, 8, and 9. The procedure in block 44 is performed in response to a determination that the first character of the bank card number is one of the values or that the procedure in block 47 is performed in response to a determination that the first character of the bank card number is not one of the values. In various embodiments, the first character of a valid bank card number is one of 1, 3, 4, 5, 6, 8, and 9.

Block 44: It is determined whether the total number of characters of the bank card number is within a pre-defined range, e.g., 15 to 19. The procedure in block 45 is performed in response to a determination that the total number of characters of the bank card number is within 15 to 19 or the procedure in block 47 is performed in response to a determination that the total number of characters of the bank card number is not within 15 to 19. According to various embodiments, bank card numbers generally have 15 to 19 digits.

Block 45: It is determined whether a bank identity (e.g., the BIN) in the bank card number is a valid bank identity. The procedure in block 46 is performed in response to a determination that the bank identity in the bank card number is a valid bank identity or the procedure in block 47 is performed in response to a determination that the bank identity in the bank card number is not a valid bank identity.

Block 46: It is determined that the bank card number is valid and the process is terminated.

Block 47: Prompt information on an error and reasons for the error are presented to the user and the process is terminated.

The process as shown in FIG. 4 is merely an example and is not for limiting the technical mechanism. According to various embodiments, the order of the procedures 42, 43, and 44 may be interchanged according to the requirements. According to various embodiments, the procedure 45 may be carried out before procedures 42, 43, and 44, and so on.

According to the dynamic validating method, when each character of a to-be-validated bank card number is input by a user, it is determined whether the character conforms to a composition rule of bank card numbers. When it is determined that a bank identity in the bank card number has been obtained, it is determined whether the bank identity is a valid bank identity. When it is determined that the user has finished inputting the bank card number, that each character of the bank card number conforms to the composition rule of bank card numbers, and that the bank identity in the bank card number is a valid bank identity, it is determined the bank card number is valid.

As described above, the method of determining whether the bank card number conforms to a composition rule of bank card numbers may include determining whether each character in the bank card number is a number and determining whether the first character of the bank card number is one of pre-defined possible values. According to various embodiments, the method may also include determining whether the total number of characters of the bank card number are within a pre-defined value range.

After the user has finished inputting the to-be-validated bank card number, the method may also include determining whether the total number of characters of the bank card number are within a pre-defined value range. It is determined that the bank card number is valid in response to a determination that the total number of characters of the bank card number are within the pre-defined value range, that each character of the bank card number conforms to the composition rule of bank card numbers, and that the bank identity in the bank card number is a valid bank identity.

For example, supposing a user is inputting a bank card number 623451234554321, after the user inputs the first character, “6”, it is determined whether the first character is a number and is one of 1, 3, 4, 5, 6, 8, and 9. If the first character is a number and is one of numbers 1, 3, 4, 5, 6, 8, and 9, the following procedures are performed. If the first character is not a number or is not one of the numbers, prompt information on an error and reasons for the error, e.g., “the input character is not a number” or “the value of the number does not comply to rules” is presented to the user. After the user inputs the second character, “2”, it is determined whether the character is a number. If the character is a number, the following procedures are performed; otherwise, prompt information on an error and reasons for the error, e.g., “the inputted character is not a number” or the like, are presented to the user. The above procedures are repeated until the user has finished inputting the bank identity “623451” and it is determined whether the bank identity is a valid bank identity. If the bank identity is a valid bank identity, the above repeating process continues; otherwise, prompt information on an error and reasons for the error, e.g., “the bank identity does not exist” or the like, are presented to the user. After the user has finished inputting “623451234554321” and has confirmed that the input is complete, it is determined whether the total number of characters of the bank card number is within 15 to 19. If the total number of characters is within 15 to 19, it is determined that the bank card number “623451234554321” is valid; otherwise, prompt information on an error and reasons for the error, e.g., “card number is too long” or “card number is too short” or the like, are presented to the user.

Suppose a user was meant to input a card number of a bank card issued by China Construction Bank, but mistakenly takes out a gift card for shopping in a supermarket and starts to input the card number of the gift card. According to the static validating manner, the card number is validated after all the characters of the card number have been input and prompt information on an error and reasons for the error are presented to the user if the validation process finds that the first character of the card number does not comply to a pre-defined rule, e.g., the first character is 7, which is not a valid value. The user may recognize the mistake after seeing the prompted information and then has to delete the already input characters of the card number and re-input the correct bank card number. In contrast, according to the dynamic validating manner, prompt information on an error is presented to the user immediately after the user inputs the first character of the card number. Thus, the user needs to delete the first character input and input the correct bank card number instead of having to delete the complete gift card number after inputting the gift card number, thus, time and effort are saved.

The procedure of determining whether a bank identity in the to-be-validated bank card number is a valid bank identity according to the static validating manner or the dynamic validating manner may include determining whether the bank identity obtained from the to-be-validated bank card number is one of standard bank identities (i.e., identities of legal banks that issue bank cards) stored in a pre-defined library of bank identities. The library of bank identities may be manually established and maintained, e.g., deleting, adding, modifying, and the like. According to various embodiments, a new bank identity may be regarded as invalid because the new bank identity has not been timely added into the library of bank identities. As a result, bank card numbers including the new bank identity may be determined to be invalid according to the above validating process.

In order to avoid the above situation, when a bank identity in a to-be-validated card number is determined to not be one of standard bank identities stored in the library of bank identities, the bank card number may be regarded as a valid bank card number if the band identity in the bank card number can be validated using another pre-defined manner. The pre-defined manners may be determined according to the requirements and are not limited in the present disclosure.

As in the foregoing, the library of bank identities may store standard bank identities of various banks that issue bank cards and the bank identity in the to-be-validated bank card number may be compared to each of the standard bank identities. If a match can be found, i.e., the bank identity is identical to one of the standard bank identities, the bank identity in the bank card number is determined to be a valid bank identity.

The library of bank identities may also store card origin information of each standard bank identity in addition to the standard bank identities. The card origin information may include information of an organization that issued the card (e.g., the bank that issued the card) and the type of the card. The bank that issued the card may include, for example, China Agriculture Bank, China Construction Bank, and the like. The type of the card may include a debit card, a credit card, and the like.

According to various embodiments, the type of card may also include a quasi-credit card in addition to a debit card and a credit card. Quasi-credit cards are generally not classified into an individual category by banks, but are classified into the category of debit cards or credit cards. The category to which the quasi-credit cards belong is decided by the bank that issues the cards. Quasi-credit cards are generally handled as credit cards.

According to various embodiments, the library of bank identities may be divided into plural sub libraries, e.g., a sub library of common bank identities and a sub library of uncommon bank identities. The sub library of common bank identities may store the most-frequently used standard bank identities and corresponding card origin information. The sub library of uncommon bank identities may store seldom used standard bank identities and corresponding card origin information. As such, when a bank identity obtained from a to-be-validated card number is compared with bank identities in the library of bank identities, the bank identity may first be compared with each of the bank identities in the sub library of common bank identities according to various embodiments, and then compared with each of bank identities in the sub library of uncommon bank identities if no match is found in the sub library of common bank identities. This can increase the speed of finding a matched bank identity in contrast to the mechanism using a single library having no sub libraries.

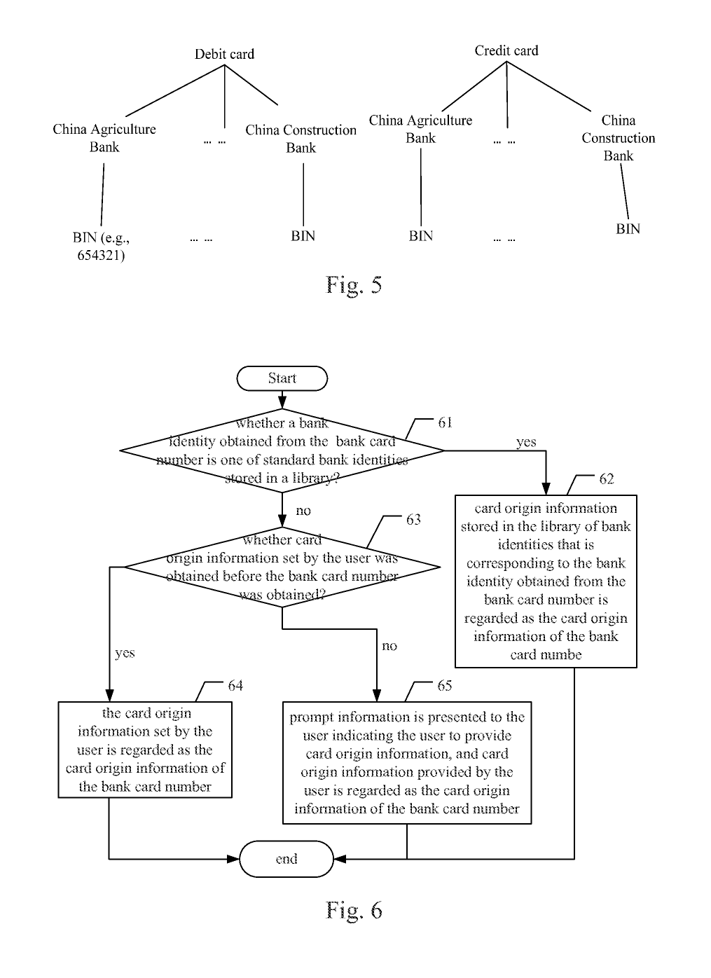

According to various embodiments, information in a sub library may be stored in three hierarchies, e.g., a first hierarchy stores the card types, a second hierarchy stores information of the banks issuing the cards, and a third hierarchy stores the standard bank identities. FIG. 5 is a diagram illustrating storage data in a sub library according to various embodiments of the present disclosure.

According to various embodiments, a bank identity may correspond to one piece of card origin information and one piece of card origin information may correspond to plural bank identities. The library of bank identities may be implemented by and accessed via, but not limited to, Javascript (JS), text file (TXT), and the like. Accordingly, after a bank card number is determined to be valid, card origin information corresponding to the bank card number may be determined by using the library of bank identities and the bank identity obtained from the bank card number. Several embodiments of the process are described below.

According to various embodiments, it is required that the user provide original card information before inputting the to-be-validated bank card number and the bank identity obtained from the to-be-validated bank card number is one of standard bank identities stored in the library of bank identities.

In various embodiments, different banks and different card types may be presented to the user to select from before the user is required to input the to-be-validated bank card number. The bank and the card type selected by the user are determined to be the card origin information set by the user.

It is then determined whether the card origin information set by the user is consistent with card origin information stored in the library that is corresponding to the bank identity obtained from the bank card number. If the card origin information set by the user is consistent with the card origin information stored in the library, the card origin information stored in the library of bank identity that is corresponding to the bank identity obtained from the bank card number is regarded as the card origin information of the bank card number. If the card origin information is inconsistent with the card origin information stored in the library, the card origin information stored in the library of bank identities that is corresponding to the bank identity in the bank card number is regarded as the card origin information of the bank card number and prompt information on an error may be presented to the user, e.g., prompting “selection error” or the like.

According to various embodiments, it is required that the user provide original card information before inputting the to-be-validated bank card number and the bank identity obtained from the to-be-validated bank card number is one of standard bank identities stored in the library of bank identities.

In this situation, the card origin information stored in the library of bank identities that is corresponding to the bank identity obtained from the bank card number is regarded as the card origin information of the bank card number.

In the above two situations, regardless of whether the user has provided card origin information, the card origin information stored in the library of bank identities that is corresponding to the bank identity obtained from the bank card number is taken as the card origin information of the bank card number as long as the bank identity obtained from the to-be-validated bank card number is found to be one of the standard bank identities stored in the library of bank identities.

According to various embodiments, it is required that the user provide original card information before inputting the to-be-validated bank card number and the bank identity obtained from the to-be-validated bank card number is not one of standard bank identities stored in the library of bank identities.

In this situation, the card origin information set by the user may be taken as the card origin information of the bank card number. According to various embodiments, it is required that the user provide card origin information before inputting the to-be-validated bank card number and the bank identity obtained from the to-be-validated bank card number is not one of standard bank identities stored in the library of bank identities.

In this situation, information may be presented to prompt the user to first provide card origin information. According to various embodiments, different banks and different card types may be presented to the user to select from. The bank and the card type selected by the user are regarded as the card origin information set by the user. The card origin information set by the user is then regarded as the card origin information of the bank card number.

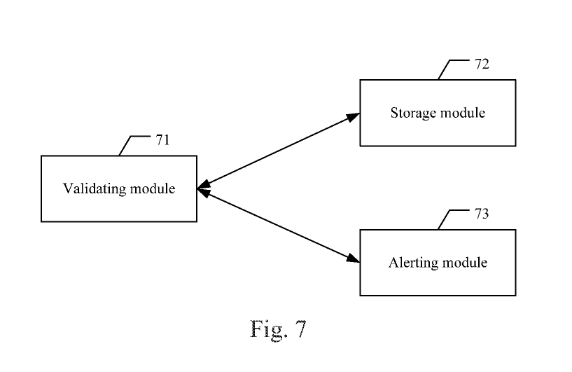

FIG. 6 is a flowchart illustrating a method of determining card origin information of a bank card number according to various embodiments of the present disclosure. As shown in FIG. 6, the method may include the following procedures.

Block 61: It is determined whether a bank identity obtained from a to-be-validated bank card number is one of standard bank identities stored in a library of bank identities. The procedure in block 62 is performed if the bank identity is one of the bank identities stored in the library and the procedure in block 63 is performed if the bank identity is not one of the bank identities stored in the library.

Block 62: Card origin information stored in the library of bank identities that is corresponding to the bank identity obtained from the bank card number is regarded as the card origin information of the bank card number.

Block 63: It is determined whether card origin information set by the user was obtained before the bank card number was obtained. The procedure in block 64 is performed if the card origin information set by the user was obtained and the procedure in block 65 is performed if the card origin information set by the user has not been obtained.

Block 64: The card origin information set by the user is regarded as the card origin information of the bank card number.

Block 65: Prompt information is presented to the user indicating the user to provide card origin information, card origin information provided by the user is regarded as the card origin information of the bank card number, and the process is terminated.

According to various embodiments, some users may be unable to correctly identify the bank that issued the bank card of the users, e.g., a user may mistakenly regard a bank card issued by a Rural Credit Cooperative to be a bank card issued by China Agriculture Bank, and some users may be unable to identify the correct card type of bank cards, e.g., a debit card may be mistaken for a credit card. According to various embodiments, after obtaining card origin information of a to-be-validated bank card number, the card origin information may be presented to the user so that the user is informed of the correct bank information and the correct card type of the bank card used by the user.

According to various embodiments, re-validation is adopted. According to various embodiments, two additional validation methods are also provided, which are referred to respectively as a second validation and a third validation, in addition to the above described static validating and dynamic validating, which are referred to as a first validation.

The second validation method is as follows. After card origin information of a to-be-validated bank card number is determined, it may be determined that the bank card is not a debit card. If the bank card is not a debit card, a “modulus 10” algorithm is applied to validate the bank card number. If the bank card number has passed the “modulus 10” algorithm validate, the bank card number is determined to pass the re-validation.

The “modulus 10” algorithm is also referred to as Luhn algorithm. Composition specifications of bank card numbers rule that card numbers of non-debit cards, e.g., credit cards, should be composed such that they can be validated by using “modulus 10” algorithms. Thus, when a bank card is not a debit card, the card number can be validated by using a “modulus 10” algorithm.

The third validation method is as follows. A bank card number generally has 15 to 19 digits. Bank card numbers having different card origin information may have a different number of digits. For example, credit cards issued by China Construction Bank each have 18 digits, while credit cards issued by Guangdong Development Bank each have 19 digits.

Therefore, after card origin information of a to-be-validated bank card number is obtained, it may be further judged whether the total number of digits of the bank card number equals a pre-defined value. The pre-defined value is the pre-defined total number of digits of a bank card number corresponding to the card origin information of the to-be-validated bank card number. If the total number of digits equals the pre-defined value, it is determined that the bank card number has passed the re-validation.

According to various embodiments, a bank card number may be validated by using the first validation method or by using the first validation method together with the second validation method or with the third validation method or by using the first validation method together with the second validation method and the third validation method. The order of the validation methods being applied is not limited, e.g., the second validation method may be applied first, and the third validation method may be applied after the second validation method, or the like. During the validating process, prompt information of an error and reasons for the error may be presented to the user in response to any inconformity with the bank card number. The method of validating bank card numbers may be implemented at a webpage or via an interface provided by a common gateway interface (CGI).

Various embodiments of the present disclosure also provide an apparatus for validating card numbers. FIG. 7 is a diagram illustrating modules of an apparatus for validating card numbers. As shown in FIG. 7, the apparatus may include a validating module 71.

A validating module 71 may obtain a card number input by a user using a terminal device, determine whether an organization identity obtained from a card number is an identity of an organization that issues cards, and make a determination that the card number is invalid if the identity of the organization obtained from the card number is not an identity of an organization that issues cards.

According to various embodiments, the validating module 71 may determine whether the organization identity obtained from the card number is an identity of an organization that issues cards after determining that a user has finished inputting the card number or as soon as it is determined that the organization identity is obtainable from at least one already input character of the card number.

According to various embodiments, the validating module 71 may determine whether the card number conforms to a composition rule and make a determination that the card number is invalid if the card number does not conform to the composition rule.

According to various embodiments, the validating module 71 may perform at least one of the following:
determining whether the first character of the card number is one of the pre-defined values;
determining whether a set of at least one character in the card number conforms to a pre-defined rule;
determining whether the total number of characters in the card number is within a pre-defined value range; and
validating the card number using a pre-defined algorithm;

In various embodiments, the validating module 71 may determine that the card number is invalid in response to one of the following determinations:
the first character of the card number is not one of the pre-defined values;
the set of at least one character in the card number does not conform to the pre-defined rule;
the total number of characters in the card number is within a pre-defined value range; and
the card number fails the validation using the pre-defined algorithm.

According to various embodiments, the validating module 71 may obtain the card number that needs to be validated to make a determination that the card number is valid if the card number conforms to a composition rule of card numbers and an organization identity obtained from the card number is an identity of a valid organization that issues cards and to make a determination that the card number is invalid if the card number does not conform to the composition rule of card numbers or if the organization identity obtained from the card number is not an identity of a valid organization that issues cards.

The validating module 71 may determine whether the card number conforms to the composition rule of card numbers and whether the organization identity obtained from the card number is an identity of a valid organization that issues cards respectively after determining a user has finished inputting the card number and determine the card number is valid in response to a determination that the card number conforms to the composition rule of card numbers and that the organization identity obtained from the card number is an identity of a valid organization that issues cards.

Alternatively, the validating module 71 may determine whether each character of the card number conforms to the composition rule of card numbers after the character is input by the user, determine whether the organization identity obtained from the card number is an identity of a valid organization that issues cards after determining that the identity of the organization has been obtained from already input characters of the card number, and determine the card number is valid in response to a determination that the user has finished inputting the card number and that each character of the card number conforms to the composition rule of card numbers and that the organization identity obtained from the card number is an identity of a valid organization that issues cards.

The composition rule may include that each character of the card number is a number and the first character of the card number is one of a pre-defined value. The composition rule may also include that the total number of characters in the card number is within a pre-defined value range.

According to various embodiments, the validating module 71 may also determine whether the total number of characters in the card number is within the pre-defined value range after determining that the user has finished inputting the card number and determine the card number is valid if the total number of characters of the card number is within the pre-defined value range and each character of the card number conforms to the composition rule of card numbers and the organization identity obtained from the card number is an identity of a valid organization that issues cards.

As shown in FIG. 7, the apparatus may also include a storage module 72.

The validating module 71 may determine that the organization identity obtained from the card number is an identity of a valid organization that issues cards in response to a determination that the organization identity is one of organization identities stored in a pre-defined library of organization identities or in response to a determination that the organization identity is not one of the organization identities stored in the library, but is determined to be a valid organization identity using another manner.

The storage module 72 may store the library of organization identities. The library of organization identities stores standard organization identities (i.e., identities of legal organizations that issue cards).

The library of organization identities may also store card origin information corresponding to each standard organization identity. Card origin information may include information of an organization and a card type.

The validating module 71 may also determine whether the library of organization identities stores card origin information corresponding to the organization identity obtained from the card number after determining the card number is valid, regard the card origin information stored in the library corresponding to the organization identity obtained from the card number as card origin information of the card number in response to a determination that the library stores card origin information corresponding to the organization identity obtained from the card number; determine whether card origin information set by the user has been obtained in response to a determination that the library does not store the card origin information corresponding to the organization identity obtained from the card number, regard the card origin information set by the user as the card origin information of the card number in response to a determination that the card origin information set by the user has been obtained, present information prompting the user to provide card origin information in response to a determination that the card origin information set by the user has not been obtained, and regard card origin information input by the user as the card origin information of the card number.

The validating module 71 may also present the card origin information of the card number to the user after the card origin information is determined.

The validating module 71 may also determine whether the card type in the card origin information of the card number is a non-debit card after the card origin information of the card number is determined, validate the card number by using a “modulus 10” algorithm, and make a determination that the card number has passed re-validation if the card number passed the validation of the “modulus 10” algorithm.

The validating module 71 may also judge whether the total number of characters in the card number equals a pre-defined value after the card origin information of the card number has been obtained and make a determination that the card number has passed re-validation if the total number of characters in the card number equals the pre-defined value. The pre-defined value is a pre-defined total number of characters in a card number corresponding to the card origin information of the card number.

As shown in FIG. 7, the apparatus may also include an alerting module 73. The validating module 71 may also instruct the alerting module 73 to present prompt information on an error and reasons for the error to the user in response to any inconformity of the card number.

The apparatus as shown in FIG. 7 may function according to the above method embodiments which are not repeated herein.

According to the above technical mechanisms, the validity of card numbers is determined based on a composition rule of card numbers and identities of organizations that issue cards. A card number is determined to be valid only when the card number satisfies the composition rule and an organization identity obtained from the card number is an identity of a valid organization that issues cards. Comprehensive factors are validated according to various embodiments of the present disclosure compared to conventional validating mechanisms, thus, the validate results can be more accurate.

According to various embodiments, reasons for an error found during the validation are presented to the user to enable the user to timely correct the error and determine the correct card number. Time and effort on behalf of the user to input the card number is reduced.

Further, the mechanism provided by various embodiments can stop some of the invalid card numbers from entering the system, thus, the risks faced by the system with regard to counterfeit card numbers are reduced.

The mechanism is applicable to various scenarios, e.g., a webpage, an application in a PC or in a mobile terminal device and the like, which are not listed herein.

It should be understood that in the above processes and structures, not all of the procedures and modules are necessary. Certain procedures or modules may be omitted according to the requirements. The order of the procedures is not fixed and can be adjusted according to the requirements. The modules are defined based on function simply for facilitating description. In implementation, a module may be implemented by multiple modules and functions of multiple modules may be implemented by the same module. The modules may reside in the same device or distribute in different devices. The “first”, “second” in the above descriptions are merely for distinguishing two similar objects, and have no substantial meanings.

According to various embodiments, a module may be implemented by hardware and/or machine-executable instructions. For example, a hardware module may comprise dedicated circuitry or logic that is permanently configured (e.g., as a special-purpose processor, such as a field programmable gate array (FPGA) or an application-specific integrated circuit (ASIC) to perform certain operations. A module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

A machine-readable storage medium is also provided, which stores instructions to cause a machine to execute a method as described herein. More particularly, a system or apparatus having a storage medium which stores machine-readable program codes for implementing functions of any of the above embodiments and which may make the system or the apparatus (or CPU or MPU) read and execute the program codes stored in the storage medium. In addition, instructions of the program codes may cause an operating system running in a computer to implement part or all of the operations. In addition, the program codes implemented from a storage medium are written in a storage device in an extension board inserted in the computer or in a storage in an extension unit connected to the computer. In various embodiments, a CPU in the extension board or the extension unit executes at least part of the operations according to the instructions based on the program codes to implement the technical scheme of any of the above embodiments.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM, and so on. Optionally, the program code may be downloaded from a server computer via a communication network.

The scope of the claims should not be limited by the embodiments set forth in the embodiments, but should be given the broadest interpretation consistent with the description as a whole.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A method of validating card numbers, comprising:
obtaining a card number inputted by a user using a terminal device;
determining whether an organization identity obtained from the card number is an identity of an organization that issues cards; and making a determination that the card number is invalid if the organization identity obtained from the card number is not the identity of the organization that issues cards.

2. The method of claim 1, wherein before the determining whether an organization identity obtained from the card number is an identity of an organization that issues cards, the method comprises:
determining a user has finished inputting the card number or determining the organization identity is obtainable from at least one already inputted character of the card number.

3. The method of claim 1, wherein determining whether an organization identity obtained from a card number is an identity of an organization that issues cards comprises:
determining whether the organization identity obtained from the card number is in a pre-defined library that stores identities of valid organizations that issue cards; wherein making a determination that the card number is invalid if the organization identity obtained from the card number is not an identity of an organization that issues cards comprises: making a determination that the card number is invalid if the organization identity obtained from the card number is not in the pre-defined library.

4. The method of claim 3, wherein the pre-defined library of organization identities further store card origin information corresponding to each of the identities of valid organizations, the card origin information comprises: information of an organization and a card type;
wherein the method further comprises:
determining whether the library of organization identities stores card origin information corresponding to the organization identity obtained from the card number, determining the card origin information as card origin information of the card number in response to a determination that the library stores the card origin information corresponding to the organization identity;
determining whether card origin information set by a user has been obtained in response to a determination that the library does not store the card origin information, determining the card origin information set by the user as card origin information of the card number, and presenting information prompting the user to provide card origin information in response to a determination that the card origin information set by the user has not been obtained, and determining card origin information provided by the user as the card origin information of the card number.

5. The method of claim 4, further comprising:
presenting the card origin information of the card number to the user after the card origin information of the card number is determined.

6. The method of claim 4, further comprising:
determining whether the card type in the card origin information of the card number is non-debit card after the card origin information of the card number is determined, validating the card number using a Luhn algorithm, and determining the card number is invalid in response to a determination that the card number fails the validation of the Luhn algorithm.

7. The method of claim 4, further comprising:
determining whether the total number of characters in the card number equals a pre-defined value corresponding to the card origin information of the card number after the card origin information of the card number is determined, and determining the card number is invalid in response to a determination that the total number of characters in the card number does not equal the pre-defined value; wherein the pre-defined value is a pre-defined total number of characters in a card number corresponding to the card origin information of the card number.

8. The method of claim 1, further comprising:
determining whether the card number conforms to a composition rule, and making a determination that the card number is invalid if the card number does not conform to the composition rule.

9. The method of claim 8, wherein the determining whether the card number conforms to the composition rule comprises at least one of:
determining whether the first character of the card number is one of pre-defined values;
determining whether a set of at least one character in the card number conforms to a pre-defined rule;
determining whether the total number of characters in the card number is within a pre-defined value range;
validating the card number using a pre-defined algorithm;
wherein the making a determination that the card number is invalid if the card number does not conform to the composition rule comprises determining that the card number is invalid in response to one of the following determinations:
the first character of the card number is not one of pre-defined values;
the set of at least one character in the card number does not conform to the pre-defined rule;
the total number of characters in the card number is within a pre-defined value range;
the card number fails the validation using the pre-defined algorithm.

10. The method of claim 1, further comprising:
presenting prompt information of an error and reasons for the error to the user in response to a determination that the card number is invalid.

11. An apparatus of validating card numbers, comprising: a processor and a memory; wherein the memory comprises a series of computer-executable instructions capable of causing the processor to perform actions of:
obtaining a card number inputted by a user using a terminal device,
determining whether an organization identity obtained from a card number is an identity of an organization that issues cards, and
making a determination that the card number is invalid if the identity of the organization obtained from the card number is not the identity of the organization that issues cards.

12. The apparatus of claim 11, wherein the computer-executable instructions are further capable of causing the processor to perform actions of:
determining a user has finished inputting the card number or determining the organization identity is obtainable from at least one already inputted character of the card number before determining whether the organization identity obtained from the card number is an identity of an organization that issues cards.

13. The apparatus of claim 11, wherein the computer-executable instructions are further capable of causing the processor to perform actions of:
determining whether the organization identity obtained from the card number is in a pre-defined library that stores identities of valid organizations that issue cards, and
making a determination that the card number is invalid if the organization identity obtained from the card number is not in the pre-defined library;
wherein the memory further stores the pre-defined library, the library storing identities of valid organizations that issue cards.

14. The apparatus of claim 13, wherein
the memory further stores in the pre-defined library card origin information corresponding to each of the identities of valid organizations, the card origin information comprising: information of an organization and a card type;
wherein the computer-executable instructions are further capable of causing the processor to perform actions of:
determining whether the library of organization identities stores card origin information corresponding to the organization identity obtained from the card number,
determining the card origin information stored in the library corresponding to the organization identity obtained from the card number to be card origin information of the card number in response to a determination that the library stores the card origin information corresponding to the organization identity obtained from the card number;
determining whether card origin information set by the user has been obtained in response to a determination that the library does not store the card origin information corresponding to the organization identity obtained from the card number;
determining the card origin information set by the user as the card origin information of the card number in response to a determination that the card origin information set by the user has been obtained;
presenting information prompting the user to provide card origin information in response to a determination that the card origin information set by the user has not been obtained, and
determining card origin information inputted by the user as the card origin information of the card number.

15. The apparatus of claim 14, wherein the computer-executable instructions are further capable of causing the processor to perform actions of:
presenting the card origin information of the card number to the user after the card origin information is determined.

16. The apparatus of claim 14, wherein the computer-executable instructions are further capable of causing the processor to perform actions of:
determining whether the card type in the card origin information of the card number is non-debit card after the card origin information of the card number is determined,
validating the card number by using a Luhn algorithm, make a determination that the card number is invalid if the card number fails the validation of the Luhn algorithm.

17. The apparatus of claim 14, wherein the computer-executable instructions are further capable of causing the processor to perform actions of:
determining whether the total number of characters in the card number equals a pre-defined value corresponding to the card origin information of the card number after the card origin information of the card number has been obtained, and
making a determination that the card number is invalid if the total number of characters in the card number does not equal the pre-defined value; wherein the pre-defined value is a pre-defined total number of characters in a card number corresponding to the card origin information of the card number.

18. The apparatus of claim 11, wherein the computer-executable instructions are further capable of causing the processor to perform actions of:
determining whether the card number conforms to a composition rule, and
making a determination that the card number is invalid if the card number does not conform to the composition rule.

19. The apparatus of claim 18, wherein the computer-executable instructions are further capable of causing the processor to perform at least one of actions of:
determining whether the first character of the card number is one of pre-defined values;
determining whether a set of at least one character in the card number conforms to a pre-defined rule;
determining whether the total number of characters in the card number is within a pre-defined value range; and
validating the card number using a pre-defined algorithm;
wherein the computer-executable instructions are further capable of causing the processor to perform actions of: determining that the card number is invalid in response to one of the following determinations:
the first character of the card number is not one of pre-defined values;
the set of at least one character in the card number does not conform to the pre-defined rule;
the total number of characters in the card number is within a pre-defined value range; and
the card number fails the validation using the pre-defined algorithm.

20. The apparatus of claim 11, wherein the computer-executable instructions are further capable of causing the processor to perform actions of:
instructing the alerting module to present prompt information on an error and reasons for the error in response to a determination that the card number is invalid.
